(19) United States
(12) Patent Application Publication
(10) Pub. No.: US 2014/0016794 A1
(43) Pub. Date: Jan. 16, 2014

(54) ECHO CANCELLATION SYSTEM AND METHOD WITH MULTIPLE MICROPHONES AND MULTIPLE SPEAKERS

(71) Applicant: Conexant Systems, Inc., Irvine, CA (US)

(72) Inventors: Youhong Lu, Irvine, CA (US); Trausti Thormundsson, Irvine, CA (US); Chris Gao, Mississauga (CA)

(21) Appl. No.: 13/941,350

(22) Filed: Jul. 12, 2013

Related U.S. Application Data
(60) Provisional application No. 61/671,527, filed on Jul. 13, 2012.

(51) Int. Cl. H04R 3/00

(52) U.S. Cl. CPC H04R 3/002
USPC 381/66

(57) ABSTRACT

An audio processing system comprising two or more microphones and an echo cancellation system configured to apply a fast converging adaptive filtering algorithm to low frequency bands of a first microphone signal to generate first synthesized echo signal components and an adaptive filtering algorithm to high frequency bands of the first microphone signal to generate second synthesized echo signal components and to apply the first synthesized echo signal components and the second synthesized echo signal components to the first microphone signal to cancel an echo signal of the first microphone signal. An echo estimate and suppression system is configured to receive the first synthesized echo signal components and the second synthesized echo signal components and to apply them to estimate powers of echo signals in one or more additional microphones.

### RELATED APPLICATIONS

This application claims benefit of U.S. Provisional Patent Application Ser. No. 61/671,527, filed Jul. 13, 2012, which is hereby incorporated by reference for all purposes as if set forth herein in its entirety, and is related to U.S. patent application Ser. No. 12/684,829, entitled “Systems and Methods for Echo Cancellation and Echo Suppression,” filed Jan. 8, 2010, U.S. Provisional Patent Application Ser. No. 61/516,088, filed Mar. 28, 2011, and U.S. patent application Ser. No. 13/431,662, entitled “Nonlinear Echo Suppression,” filed Mar. 27, 2012.

### TECHNICAL FIELD

The present disclosure relates to audio processing systems and methods, and more specifically to audio processing systems and methods for performing echo cancellation for multiple microphones and multiple speakers.

### BACKGROUND OF THE INVENTION

Echo cancellation is performed on audio signals to remove echo signals that can reduce the quality of the audio signals. While many echo cancellation systems and methods are known, the amount of processing required to remove echo signals can be significant in terms of processing time or resources, and the ability to effectively remove the echo signals can be significantly impaired as a result of system configurations.

### SUMMARY OF THE INVENTION

An audio processing system is provided that includes two or more microphones and an echo cancellation system configured to apply a fast converging adaptive filtering algorithm to low frequency bands of a first microphone signal to generate first synthesized echo signal components and an adaptive filtering algorithm to high frequency bands of the first microphone signal to generate second synthesized echo signal components and to apply the first synthesized echo signal components and the second synthesized echo signal components to the first microphone signal to cancel an echo signal of the first microphone signal. An echo estimate and suppression system is configured to receive the first synthesized echo signal components and the second synthesized echo signal components and to apply them to estimate powers of echo signals in one or more additional microphones.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a design configuration including loudspeakers and microphones in accordance with an exemplary embodiment of the present disclosure;

FIG. 2 is a diagram of a system using relational filters a₁ and a₂ in accordance with an exemplary embodiment of the present disclosure; and

FIG. 3 is a diagram of an algorithm for processing audio data in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

Multimedia systems may use several loudspeakers to generate a desired sound image for users and several microphones to record the local audio with high fidelity for transmission to a remote site. The high fidelity local sound recording requires that the sound enhancement system needs to be capable of canceling echo signals, without significantly increasing cost.

In such systems, cancelling echo signals in all microphones and cancelling echo signals caused from coupling with all loudspeakers can be used to improve sound quality. However, if each microphone is provided with an echo canceller that includes a linear adaptive filtering algorithm, full-duplex nonlinear processing and post nonlinear processing, the cost would prevent the commercial application of such an echo canceller.

The present disclosure utilizes linear echo cancellation to track echo signals in one microphone that may be created from multiple loudspeakers, using an adaptive filtering algorithm. Echo cancellation is implemented in a sub-band domain such that an Affine Projection Adaptation (APA) algorithm or other fast convergence adaptive filtering algorithms can be used in lower frequency bands and a normalized least mean square (NLMS) algorithm can be used in higher frequency bands. The echo signal corresponding to each loudspeaker is then used to estimate the echo in other microphones from the same loudspeaker. In order for beam-forming after echo cancellation to work properly, the phase can be kept the same for all microphone signals by using the same echo suppression parameters for all microphones.

The present disclosure can be implemented using a number of components. A first exemplary component can perform echo cancellation in a first microphone. The first component can include a linear adaptive filtering echo cancellation algorithm, where different frequency bands use different algorithms, such as where an adaptive filter algorithm is selected for lower frequency bands that uses faster convergence, full-duplex nonlinear processing, and post nonlinear processing. The linear adaptive filtering algorithm can have N adaptive filters corresponding to N loudspeakers, where N is an integer equal to or greater than 1, and each adaptive filter can output a synthesized echo to match the echo due to a corresponding loudspeaker. The adaptation works such that the adaptive filters will converge to true echo paths when the correlations among loudspeaker signals are varying, and adaptive filters will converge to a linear combination of the true echo paths if the correlations among loudspeaker signals are fixed. This embodiment will ensure that the echo signal is well modeled and cancelled even if the true echo paths are not identified and adaptive filters will not have ill-states in addition to the true echo paths.

A second exemplary component can provide echo estimate and suppression for other microphones. The synthesized echo of the first microphone corresponding to a loudspeaker or other suitable signals can be used to estimate the powers of echoes in other microphones corresponding to the same loudspeaker. The corresponding echoes in other microphones can be cancelled via spectrum subtraction or in other suitable manners.

In order to maintain phase information for additional processing that requires such phase information, the synthesized echoes of the first microphone can also be used to estimate the echo powers of the first microphone, and the echo in first microphone can be cancelled using the second exemplary component. This cancellation processing can keep the phase information for other audio processing, for example, beaming-forming processing.

A full-duplex nonlinear processor can be used to estimate the normalized cross-correlations between the first microphone and loudspeaker signals. The estimators can be used to further weight down the residual echo through a set of modification factors that correspond to different microphones.

In some configurations, the loudspeaker signals can be generated from only one or two channels, for example, for producing surround sound, 3D sound, or other suitable audio configurations. If this configuration information is known, the first component for canceling the first microphone echo can be simplified by using one or more adaptive filters, such that the reference signals are re-calculated using the producing rule of sound.

The echo cancellation system can be also simplified when the echo tail is short and consists of only a few major coefficients, such as for automotive audio applications. In this exemplary embodiment, the other microphone echo paths may be modeled using a phase and/or an amplitude difference from the echo paths of the first microphone.

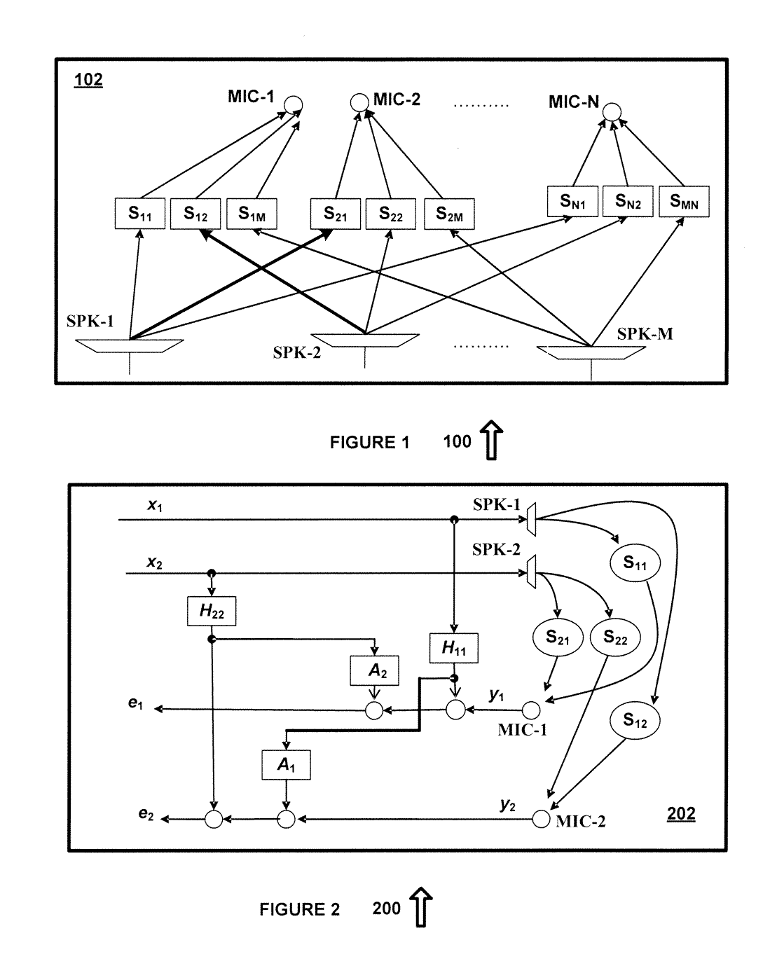

FIG. 1 is a diagram 100 of a design configuration including loudspeakers and microphones in accordance with an exemplary embodiment of the present disclosure. In order to generate a desired sound image in a given space, multimedia systems usually use several loudspeakers SPK-1 through SPK-M located at positions within a physical enclosure 102 in a way that is specified by design requirements, for example, a stereo audio system having two loudspeakers in a predetermined configuration on a consumer electronics device. Similarly, in order to obtain a sound image within a space, several microphones MIC-1 through MIC-N can be placed within the physical enclosure 102 in a way that is specified by design requirements. A different set of transfer functions exists that describes the relationship between each speaker and microphone (S₁₁, S₁₂, S_{1M}, S₂₁, S₂₂, S_{2M}, S_{N1}, S_{N2}, S_{NM}).

Recorded microphone signals can be processed so that they are transmitted for reproduction in high fidelity at a remote site. One of the major processing components for such processing is to cancel any echo signals within a hardware reasonable cost.

The received echo from each microphone contains direct coupling from each loudspeaker and reflections of the loudspeaker signal from objects surrounding the audio system, which requires a number of adaptive filters that is equal to the number of loudspeakers when adaptive filtering is implemented in time domain. Since there are several microphones, the numbers of sets of adaptive filters can be equal to the number of microphones. If an integer M stands for the number of loudspeakers and an integer N stands for the number of microphones, the echo cancellation system can require as many as M*N adaptive filters and other associated processing components. An echo cancellation system implemented in this manner can require a significant amount of memory and processing power to operate, and can be impractical to implement without a powerful and expensive processing device.

Another capability that is required of the echo cancellation system is to be able to perform echo cancellation when the loudspeaker signals are highly correlated. Non-uniqueness of adaptive filters can make the adaptive filters overflow and can cause the convergence rate to be slow. For example, if two adaptive filters are used to cancel two echo components from two loudspeakers playing identical audio signals, there will be some components that are identical in two adaptive filters, but with opposite signs. These components are not useful for canceling echo, and can be harmful to the implementation of adaptive filtering. One approach to addressing this condition is to change the loudspeaker signals so that they have less correlation, but that approach can distort the loudspeaker signals enough to be noticeable to the listener. In addition, such an approach cannot be used where the loudspeaker signals are not allowed to change, or where they are not accessible due to system design.

The present disclosure uses a linear echo cancellation system to track echo in one microphone due to multiple loudspeakers, by using an adaptive filtering algorithm. Echo cancellation is implemented in a sub-band domain, where an APA algorithm or other suitable algorithms are used in lower frequency bands and an NLMS algorithm or other suitable algorithms are used in higher frequency bands. Other suitable adaptive filtering algorithms can also or alternatively be used. Because there is more correlation in lower frequency bands among loudspeaker signals, a fast convergence algorithm can be used in those frequency bands.

Each echo signal corresponding to each loudspeaker can then be used to estimate the echo signal in other microphones from the same loudspeaker. In order for beam-forming after echo cancellation to work properly, the phase can be kept the same for all microphone signals by taking the same echo suppression for all microphones.

In order to allow the linear echo cancellation system to perform echo cancellation when the loudspeaker signals are highly correlated, the update of the adaptive filters by the adaptive filtering algorithm can use the same normalized error for all adaptive filters, and the initial value of all adaptive filters can be set to be the same. In this manner, the adaptive filters can uniquely converge to the linear combination of the true echo paths, and the performance of the echo canceller will be the same as the case where correlations of loudspeaker signals are varying.

### 1. Echo Estimation of a First Microphone Via Adaptive Filtering.

In one exemplary embodiment, a first system estimates echo signal components of a first microphone signal that are attributable to each loudspeaker. First, all signals are expanded into sub-band domains, joint time frequency domains, short-time frequency domains, or in other suitable manners. Different adaptive filtering algorithms are then applied to different bands. Suitable adaptive filtering algorithms include ones where the convergence rate is faster in lower frequency bands. For example, in the lower frequency bands, e.g., frequency bands less than 1000 Hz, an APA adaptive filtering algorithm can be used, and in other bands an NLMS adaptive filtering algorithm can be used. If the processing cost is not important, all bands can use a faster convergence algorithm.

The adaptive filtering algorithm synthesizes the echo signal components. M adaptive filters corresponding to M loudspeakers can be used and each adaptive filter can output a synthesized echo signal to match the echo signal generated by the corresponding loudspeaker. The adaptive filters can converge to true echo signal paths when the correlations among loudspeaker signals are varying, and the adaptive filters will uniquely converge to a linear combination of the true echo paths if the correlations among loudspeaker signals are fixed. In this manner, the echo signal is properly modeled and cancelled even if the true echo signal paths are not identified and the adaptive filters will converge when the loudspeaker signals are highly correlated, in addition to modeling the true echo signal paths.

If all inputs, outputs, and variables are in a joint time-frequency domain, the frequency index can be omitted in the following equations. If xₘ(n) is the audio signal played out from the m^{th} loudspeaker at time n and hₘ(n,k) is the adaptive filter at the time n and the tap k corresponding to the loudspeaker, the echo signal ŷ(n) of the first microphone signal can be estimated by the following algorithms, which can be implemented in hardware or a suitable combination of hardware and software:

ŷ(n)=Σₘ₌₀^{M-1}yₘ(n) (1)

yₘ(n)=Σₖ₌₀^{L-1}hₘ(n,k)xₘ(n−k) (2)

The left side of Eq. (2) is the m^{th} component echo signal corresponding to the m^{th} loudspeaker and integer L is the length of the adaptive filters. The adaptive filter update can be performed according to the following algorithms or in other suitable manners, which can be implemented in hardware or a suitable combination of hardware and software:

e(n)=z(n)−ŷ(n) (3)

hₘ(n+1,k)=hₘ(n,k)+u(n)e(n)xₘ(n−k) (4)

in which z(n) is the microphone signal containing an echo signal, a near-end audio signal, and near-end noise. The index m ranges from 0 to M−1.

The adaptation coefficient u(n) is an important factor for the algorithm to converge in an optimal way against noise and double talk. For example, an estimate of u(n) is presented in U.S. patent application Ser. No. 12/684,829, entitled “Systems and Methods for Echo Cancellation and Echo Suppression,” filed Jan. 8, 2010, and which is hereby incorporated by reference for all purposes, for a single loudspeaker system where minimization of a sum of square of difference between adaptive filter coefficients and the echo signal path impulse response is used.

In an NLMS adaptive filter algorithm, the adaptation coefficient u(n) is proportional to the inverse of the covariance of the loudspeaker signal xₘ(n). An APA update of coefficients is based on current values and previous errors, such that u(n) is proportional to the inverse of the auto-covariance of loudspeaker signals of order P, see “The Fast Affine Projection Algorithm,” Gay, S. L., Tavathia, S., International Conference on Acoustics, Speech, and Signal Processing, 1995. ICASSP-95, 1995 Vol. 5, pp. 3023-3026, which is hereby incorporated by reference for all purposes as if set forth herein in its entirety.

Convergence behavior is optimal for a system with multiple loudspeakers when the correlations of loudspeaker signals are varying, in the sense that adaptive filters will converge to the impulse responses of the true echo signal paths. Convergence behavior can be impeded when the correlations of loudspeaker signals are fixed, though, because the adaptive filtering algorithm can easily converge to a local or non-unique solution. This problem is difficult to solve without making the correlation of loudspeaker signals vary.

In the disclosed embodiments, an adaptation coefficient is used that can be the inverse of the covariance of all loudspeaker signals for NLMS algorithm and the auto-covariance matrix for APA algorithm and that can be identical for all adaptive filter updates. In addition, the same initial value can be used for all adaptive filters. In this manner, when the correlation of loudspeaker signals is fixed, the adaptive filter will converge to a unique solution, even though the solution might not be the true echo signal path. For example, suppose that there are two loudspeakers in the system, defined by the relationships x₁(z)=g₁(z)x(z) and x₂(z)=g₂(z)x(z), where s₁(z) is the echo signal path impulse response between the microphone and the first loudspeaker, and s₂(z) is the echo signal path impulse response of the microphone and the second loudspeaker, and where all variables are z-transformed, x(z) is the source in remote site, and g₁(z) and g₂(z) are the room impulses between microphones and the source in the remote site, respectively. The adaptive filter corresponding to a second loudspeaker signal is equal to a convolution of a fixed filter and the first adaptive filter, that is,

$${h}_{1} ( z ) = {s}_{1} ( z ) + \frac{{g}_{2} ( z ) {s}_{2} ( z )}{{g}_{1} ( z )} and {h}_{2} ( z ) = {s}_{2} ( z ) + \frac{{g}_{1} ( z ) {s}_{1} ( z )}{{g}_{2} ( z )} .$$

This solution is also a good solution, because both the convergence speed and steady state error are as good as ones from existing adaptive filtering algorithms. Note that two adaptive filters are related to each other with the fixed filter, which is the room response in the remote site.

### 2. Echo Estimate and Suppression of Other Microphones.

In one exemplary embodiment, a second system estimates echo and provides for suppression of echo in other microphones. The synthesized echo signal of the first microphone corresponding to a loudspeaker signal is used to estimate the power of echo signals in other microphones corresponding to the same loudspeaker signal, and those echo signals are cancelled via spectrum subtraction. Again, for the following equations, all variables are in the joint time-frequency domain and the frequency band index is omitted.

In this exemplary embodiment, let:

P_{y}_{ₘ}(n)=E{yₘ(n)y*ₘ(n)} be the expected echo power component of yₘ(n),
P_{z}_{ₗ}(n)=E{zₗ(n)z*ₗ(n)} be the expected l^{th} microphone signal power, and
wₘ(n) be the selected weights.

Using these algorithms, suppression of the echo signal in a microphone l can be performed using the following algorithms, which can be implemented in hardware or a suitable combination of hardware and software:

$$\begin{matrix}{e}_{l} ( n ) = {v}_{l} ( n ) {z}_{l} ( n ) & ( 5 ) \\ {v}_{l} ( n ) = {[ \frac{{P}_{{z}_{i}} ( n ) - g {\sum }_{m = 0}^{M - 1} {w}_{m} ( n ) {P}_{{y}_{m}} ( n )}{{P}_{{z}_{i}} ( n )} ]}^{v} & ( 6 )\end{matrix}$$

where 1≦l<N−1, v is positive real number, and g is an aggressiveness parameter to compensate under or over estimate of echo or to compensate microphone gain difference.

Another implementation of echo suppression is to use a different realization of vₗ(n) using the following algorithm, which can be implemented in hardware or a suitable combination of hardware and software:

$${v}_{l} ( n ) = {\prod }_{m = 0}^{M - 1} \frac{{P}_{{z}_{i}} ( n ) - {g}_{m} {w}_{m} ( n ) {P}_{{y}_{m}} ( n )}{{P}_{{z}_{i}} ( n )} \qquad ( 7 )$$

where gₘ are aggressiveness parameters to compensate for under or over estimate of echo or to compensate for microphone gain differences.

The weights wₘ(n) are positive values that are used to compensate the variation of expectation values, because a very short-term average of signal power is expected. Instant power is also considered if the weights are chosen properly.

These echo suppression methods are based on the observation that echo signal components of microphone signals resulting from the same loudspeaker signal can be very similar in terms of expectation of power, although they are different in terms of phase. Therefore, it is useful to use the expectation of power to weight down the echo because methods based on equations (6) and (7) work very well when the expectation of power of echo signal components is known and the expectation is computed via short-term average or even instant power.

### 3. Phase of Microphone Signals.

In order to store phase information for additional processing that requires the phase information, the synthesized echo signals of the first microphone can also be used to estimate the echo powers of the first microphone, and the echo signal in first microphone can be cancelled using a similar technique to the ones in Eqs. (6) and (7). This process will keep the phase information for other processing, for example, beaming-forming processing.

### 4. Full-Duplex Nonlinear Processing.

A full-duplex nonlinear processor can estimate the normalized cross-correlations between the first microphone and loudspeaker signals. The estimators can be used to further weight down the residual echo through a set of modification factors corresponding to different microphones. Additional information pertaining to full duplex nonlinear processing can be found in U.S. patent application Ser. No. 12/684,829, U.S. provisional patent application No. 61/516,088, filed Mar. 28, 2011, and U.S. patent application Ser. No. 13/431,662, entitled “Nonlinear Echo Suppression,” filed Mar. 27, 2012, each of which is hereby incorporated by reference for all purposes as if set forth herein in their entirety.

### 5. Use Specific Implementation Details of Loudspeaker Signals.

In some situation, the loudspeaker signals can be generated from only one or two channels, for example, for producing surround sound, by processing an input monaural or stereo signal. If this spatial audio information is known, the first component for canceling a first microphone echo signal can be simplified by using one or two adaptive filters, such that the reference signals are re-calculated by the producing rule of sound.

### 6. Use of Known Details Pertaining to the Echo Signal Path.

The design of echo cancellers for a system can be also simplified when the echo tail is short and consists of only a few major coefficients, such as for automobile audio systems. In this case, the other microphone echo signal paths may be just a phase and or amplitude difference in each frequency band from the echo signal paths of the first microphone.

Using a stereo system as an example where two microphones and two loudspeakers are used, the number of variables can be reduced by adding conditions to the adaptive filtering algorithm so that the adaptive filters in the algorithm will uniquely identify the true echo signal path. These conditions assume that the echo signal paths from a loudspeaker to the all microphones are related to each other and can be estimated using relative spacing information between microphones and the loudspeaker. Thus, the distance between microphones is short and fixed, and the angles between the microphones and the loudspeakers are also fixed in an audio system. Based on that information, additional conditions can be applied to the adaptive filtering algorithm so that the implementation can be simplified and adaptive filters can converge to the impulse responses of the true echo path.

One exemplary condition is that the echo signal paths from one loudspeaker to all microphones are related to each other via adaptive or time-invariant relation filters in the time domain, and can be determined using the distances between the microphones and the angles between the microphones and the loudspeakers. Although the model is not perfect because some reflections in an echo signal path may vary, the majority of the echo signal path model can be determined. The relation filters can be determined as discussed herein.

FIG. 2 is a diagram of a system 200 using relational filters a₁ and a₂ in accordance with an exemplary embodiment of the present disclosure. System 200 includes microphones MIC-1 and MIC-2 and speakers SPK-1 and SPK-2, which are disposed at known locations within enclosure 202. In this exemplary embodiment, stereo echo cancellation can be performed using the following algorithms, which can be implemented in hardware or a suitable combination of hardware and software:

ŷ₁₁(n)=Σₖ₌₀^{L-1}h₁₁(k,n)x₁(n−k) (9)

ŷ₂₂(n)=Σₖ₌₀^{L-1}h₂₂(k,n)x₂(n−k) (10)

ŷ₁(n)=ŷ₁₁(n)+a₂(n)*ŷ₂₂(n) (12)

ŷ₂(n)=a₁(n)*ŷ₁₁(n)+ŷ₂₂(n) (12)

e₁(n)=y₁(n)−ŷ₁(n) (13)

e₂(n)=y₂(n)−ŷ₂(n) (14)

hᵢᵢ(k,n+1)=hᵢᵢ(k,n)+uᵢ(n)eᵢ(n)xᵢ(n−k) (15)

uᵢ(n)=u/E{xᵢ(n)xᵢ(n)′} (16)

System 200 can produce echo signal cancellation for both microphone signals, with the processing cost for one microphone echo signal cancellation. One advantage of system 200 is that the adaptive filters will converge to the impulse responses of the true echo signal path, except for few single frequencies, even if signals x₁ and x₂ are identical and adaptive filtering is performed in the time domain.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

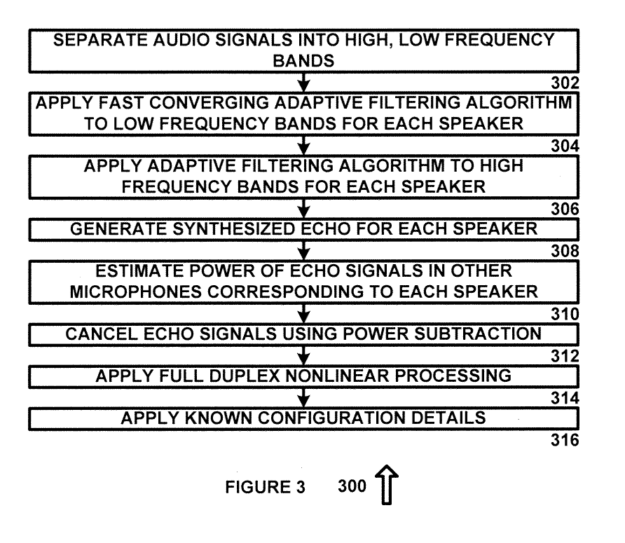

FIG. 3 is a diagram of an algorithm 300 for processing audio data in accordance with an exemplary embodiment of the present disclosure. Algorithm 300 can be implemented in hardware or a suitable combination of hardware and software, such as one or more software systems operating on a processor.

Algorithm 300 begins at 302, where audio signals for a first microphone are separated into low and high frequency bands, such as by using sub-band domains, joint time frequency domains, short-time frequency domains or in other suitable manners. The algorithm then proceeds to 304.

At 304, a fast converging adaptive filtering algorithm is applied to the lower frequency bands to generate a first synthesized echo component. For example, in the lower frequency bands, e.g., frequency bands less than 1000 Hz, an APA adaptive filtering or other suitable algorithms can be used. The algorithm then proceeds to 306.

At 306, an adaptive filtering algorithm is applied to the higher frequency bands to generate a second synthesized echo component. In one exemplary embodiment, an NLMS adaptive filtering can be used, or where processing cost is not important, all bands can use a fast convergence algorithm. The algorithm then proceeds to 308.

At 308, a synthesized echo is generated for each speaker for the first microphone signal using the first and second synthesized echo components. In one exemplary embodiment, the algorithms of equations 1-4 can be used. Likewise, other suitable algorithms can also or alternatively be used. The algorithm then proceeds to 310.

At 310, the powers of echo signals in other microphones corresponding to each speaker are estimated. In one exemplary embodiment, the powers can be estimated using the following algorithms:

P_{y}_{ₘ}(n)=E{yₘ(n)y*ₘ(n)} be the expected echo component of yₘ(n),
P_{z}_{ₗ}(n)=E{zₗ(n)z*ₗ(n)} be the expected l^{th} microphone signal, and
wₘ(n) are the selected weights.

Likewise, other suitable algorithms can also or alternatively be used. The algorithm then proceeds to 312.

At 312, the echo signals are cancelled using power subtraction. In one exemplary embodiment, the algorithms of equations 5-7 can be used, or other suitable algorithms can also or alternatively be used. The algorithm then proceeds to 314.

At 314, full duplex nonlinear processing is applied to estimate the normalized cross-correlations between the first microphone and loudspeaker signals. The estimators can be used to further weight down the residual echo through a set of modification factors corresponding to different microphones. Additional information pertaining to full duplex nonlinear processing can be found in U.S. patent application Ser. No. 12/684,829, U.S. provisional patent application No. 61/516,088, filed Mar. 28, 2011, and U.S. patent application Ser. No. 13/431,662, entitled “Nonlinear Echo Suppression,” filed Mar. 27, 2012. The algorithm then proceeds to 316.

At 316, known configuration details are applied. In one exemplary embodiment, the echo paths from one loudspeaker to all microphones can be related to each other using adaptive or time-invariant relation filters in time domain, which can be determined using distances among microphones and angles between microphones and the loudspeaker, such as by using equations 9 through 16 or in other suitable manners.

In operation, algorithm 300 allows echo cancellation to be performed in a system having multiple microphones and multiple loudspeakers with minimal processing costs and requirements. Although algorithm 300 has been shown as a flow chart algorithm that can be implemented in hardware or software operating on a processor, other suitable configurations can be used to implement algorithm 300, such as separate software systems operating on a processor, a combination of hardware and software components, a state diagram, or in other suitable manners.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. An audio processing system comprising:
two or more microphones;
an echo cancellation system configured to apply a fast converging adaptive filtering algorithm to low frequency bands of a first microphone signal to generate first synthesized echo signal components and an adaptive filtering algorithm to high frequency bands of the first microphone signal to generate second synthesized echo signal components and to apply the first synthesized echo signal components and the second synthesized echo signal components to the first microphone signal to cancel an echo signal of the first microphone signal; and
an echo estimate and suppression system configured to receive the first synthesized echo signal components and the second synthesized echo signal components and to apply them to estimate powers of echo signals in one or more additional microphones.

2. The audio processing system of claim 1 further comprising a system configured to cancel echo signals for each of the signals from the first microphone and the one or more additional microphones using power subtraction to generate output signals.

3. The audio processing system of claim 2 further comprising a system configured to perform full duplex nonlinear echo processing on the output signals to generate a processed output signal.

4. The audio processing system of claim 3 further comprising a system configured to apply one or more relation filters to the processed output signal.

5. The audio processing system of claim 4 wherein the one or more relation filters are adaptive relation filters.

6. The audio processing system of claim 4 wherein the one or more relation filters are time invariant relation filters.

7. The audio processing system of claim 1, wherein the first microphone receives an audio signal from m loudspeakers, where xₘ(n) is an audio signal played out from the m^{th} loudspeaker at time n.

8. The audio processing system of claim 7 further comprising:
an adaptive filter hₘ(n,k) at time n and tap k corresponding to the m^{th} loudspeaker; and
an echo signal ŷ(n) estimator for a signal of the microphone, wherein the echo signal estimator applies the algorithms:
ŷ(n)=Σₘ₌₀^{M-1}yₘ(n) and
yₘ(n)=Σₖ₌₀^{L-1}hₘ(n,k)xₘ(n−k).

9. The system of claim 8, wherein the adaptive filter is updated by applying hₘ(n+1,k)=hₘ(n,k)+u(n)e(n)xₘ(n−k), where e(n)=z(n)−ŷ(n), z(n) is the signal of the microphone, and index m ranges from 0 to M−1.

10. A method for processing audio comprising:
separating a signal for a first microphone into one or more high frequency bands and one or more low frequency bands;
applying a fast converging adaptive filtering algorithm to the low frequency bands to generate first synthesized echo components;
applying an adaptive filtering algorithm to the high frequency bands to generate second synthesized echo components;
generating a synthesized echo component for each of a plurality of speakers;
generating an echo signal power for signals from one or more additional microphones;
cancelling echo signals for each of the signals from the first microphone and the one or more additional microphones using power subtraction to generate output signals; and
performing full duplex nonlinear echo processing on the output signals to generate a processed output signal.

11. The method of claim 10 further comprising applying one or more relation filters to the processed output signal.

12. The method of claim 10 further comprising applying one or more time invariant relation filters to the processed output signal.

13. The method of claim 10 further comprising applying one or more adaptive relation filters to the processed output signal.

14. The method of claim 10 wherein the fast converging adaptive filtering algorithm comprises an Affine Projection Adaption algorithm.

15. The method of claim 10 wherein cancelling the echo signals for each of the signals from the first microphone and the one or more additional microphones using power subtraction to generate the output signals comprises cancelling the echo signals for each of the signals from the first microphone and the one or more additional microphones using spectral subtraction to generate the output signals.

16. A system for audio processing comprising:
a microphone receiving an audio signal from m loudspeakers, where xₘ(n) is an audio signal played out from the m^{th} loudspeaker at time n;
an adaptive filter hₘ(n,k) at time n and tap k corresponding to the m^{th} loudspeaker; and
an echo signal ŷ(n) estimator for a signal of the microphone, wherein the echo signal estimator applies the algorithms:
ŷ(n)=Σₘ₌₀^{M-1}yₘ(n) and
yₘ(n)=Σₖ₌₀^{L-1}hₘ(n,k)xₘ(n−k).

17. The system of claim 16, wherein the adaptive filter is updated by applying hₘ(n+1,k)=hₘ(n,k)+u(n)e(n)xₘ(n−k), where e(n)=z(n)−ŷ(n), z(n) is the signal of the microphone, and index m ranges from 0 to M−1.

18. The system of claim 16 further comprising a system for estimating and suppressing echo for one or more other microphones, where:
P_{y}_{ₘ}(n)=E{yₘ(n)y*ₘ(n)} is an expected echo component of yₘ(n),
P_{z}_{ₗ}(n)=E{zₗ(n)z*ₗ(n)} is an expected l^{th} microphone signal, and
wₘ(n) are predetermined weights, and wherein suppression of an echo signal in a microphone l is performed using an algorithm that applies P_{y}_{ₘ}(n), P_{z}_{ₗ}(n) and wₘ(n).

19. The system of claim 18 wherein the algorithm comprises:
$${e}_{l} ( n ) = {v}_{l} ( n ) {z}_{l} ( n ) and$$
$${v}_{l} ( n ) = {[ \frac{{P}_{{z}_{i}} ( n ) - g {\sum }_{m = 0}^{M - 1} {w}_{m} ( n ) {P}_{{y}_{m}} ( n )}{{P}_{{z}_{i}} ( n )} ]}^{v} ,$$
where 1≦l<N−1 and v is a positive real number.

20. The system of claim 18 wherein the algorithm comprises:
$${v}_{l} ( n ) = {\prod }_{m = 0}^{M - 1} \frac{{P}_{{z}_{i}} ( n ) - {g}_{m} {w}_{m} ( n ) {P}_{{y}_{m}} ( n )}{{P}_{{z}_{i}} ( n )} .$$
